(19) United States
(12) Patent Application Publication
(10) Pub. No.: US 2005/0019478 A1
(43) Pub. Date: Jan. 27, 2005

(54) Rice ball structure

(76) Inventor: Chi-Yang Yao, Chang-Hua Hsien (TW)

Correspondence Address: RABIN & BERDO, P.C.;Suite 500, 1101 14th Street, N.W., Washington, DC, 20005, US

(21) Appl. No.: 10/896,050

(22) Filed: Jul. 22, 2004

(30) Foreign Application Priority Data
Jul. 23, 2003 (TW) 92213397

(51) Int. Cl. A23K 1/00

(52) U.S. Cl. 426/618

(57) ABSTRACT

A rice ball structure in which after pliable dried meat is conveniently wrapped around differently shaped rice balls, the dried meat does not become soft and soggy as easily as sea moss, but is capable of convenient and simple extended shelf life, warehousing, and storage that involves no additional difficulty. As the dried meat is not susceptible to moisture which prevents softening and sogginess for culinary enjoyment, a variety of animal and vegetable ingredients can be selectively added during processing to integrate a range of different flavors to further enhance taste while eaten. Additionally, the dried meat does not stick to the hands when grasped which eliminates the trouble of having to wash up afterwards. Since the dried meat is unaffected by moisture and does not become soft or soggy, the original shape of the rice ball is maintained and does not deform, thereby preserving its original attractive appearance.

### BACKGROUND OF THE INVENTION

1) Field of the Invention

The invention herein relates to a rice ball structure wherein rice balls are wrapped in a layer of dried meat, which not only facilitates the wrapping procedure, but also keeps the dried meat unbroken to thereby enhance culinary flavor and taste.

2) Description of the Prior Art

Conventional rice ball structures, as indicated in FIG. 1-A and FIG. 1-B, typically consists of first placing a given quantity of cooked rice into rice ball A forming molds of different shape, a filling composed of personally preferred condiments and ingredients is next placed onto the cooked rice, and then another given quantity of cooked rice is added into the rice ball forming molds over the said condiments and ingredients, which are finally pressed into differently shaped rice balls A, the utilization of the said rice ball A forming molds facilitating the convenient, rapid (shorter cooking time), and sanitary processing of the rice ball A into a food product.

The said differently shaped rice balls A are all wrapped in sea moss B sheets of predetermined dimensions and after the differently shaped rice balls A are wrapped in a layer of sea moss B sheeting, the rice ball A production process is complete and they are ready to be eaten.

Referring to FIG. 2-A and FIG. 2-B, however, the sea moss B wrapped around the rice balls A is easily affected by humid conditions and readily absorbs moisture, or when unpackaged and not eaten, the sea moss B becomes soft and soggy, and its limited shelf life results in storage and warehouse attention and caution that are terribly inconvenient and troublesome: after the sea moss A is soft and soggy, beside variances in taste while eaten and, furthermore, bothersome washing up afterwards because sea moss B sticks to the hand when grasped, the soft and soggy sea moss B is incapable of maintaining the original shape of the rice ball A, resulting in a deformed shape that is unattractive in appearance.

### SUMMARY OF THE INVENTION

Therefore, in view of the said disadvantageous factors, the applicant of the invention herein conducted extensive research and improvement that culminated in the successful development of the present invention, which is submitted to the patent bureau as a new patent application.

The primary objective of the invention herein is to provide a rice ball structure comprised of a rice ball, dried meat, and filling in which after the pliable dried meat is wrapped around differently shaped rice balls, since the dried meat is not readily affected by ambient humid conditions and moisture absorption, or when unpackaged and not eaten, the dried meat does not become soft and soggy as easily as sea moss, but is capable of convenient and simple extended shelf life, warehousing, and storage that involves no additional difficulty; as the dried meat is not susceptible to moisture which prevents softening and sogginess and, furthermore, for culinary enjoyment, a variety of animal and vegetable ingredients can be selectively added during processing to thereby integrate a range of different flavors to further enhance taste while eaten; additionally, the dried meat does not stick to the hands when grasped which eliminates the trouble of having to wash up afterwards; and since the dried meat is unaffected by moisture and does not become soft or soggy, the original shape of the rice ball is maintained and does not deform, thereby preserving its original attractive appearance.

### BRIEF DESCRIPTION OF THE DRAWINGS

FIG. 1-A is an isometric drawing of the sea moss utilized by the prior art rice ball.

FIG. 1-B is an isometric drawing of the prior art rice ball wrapped in sea moss.

FIG. 2-A is an isometric drawing of the prior art sea moss after exposure to moisture.

FIG. 2-B is an isometric drawing of the prior art rice ball wrapped in sea moss following exposure to moisture.

FIGS. 3-A and 3-B are isometric drawings of the dried meat and meat skin of the invention herein.

FIGS. 4-A, 4-B, and 4-C are isometric drawings of the invention herein that illustrate the wrapping of the rice ball in the dried meat.

FIGS. 5-A, 5-B, and 5-C are isometric drawings of the invention herein showing various shapes of rice balls wrapped in the dried meat.

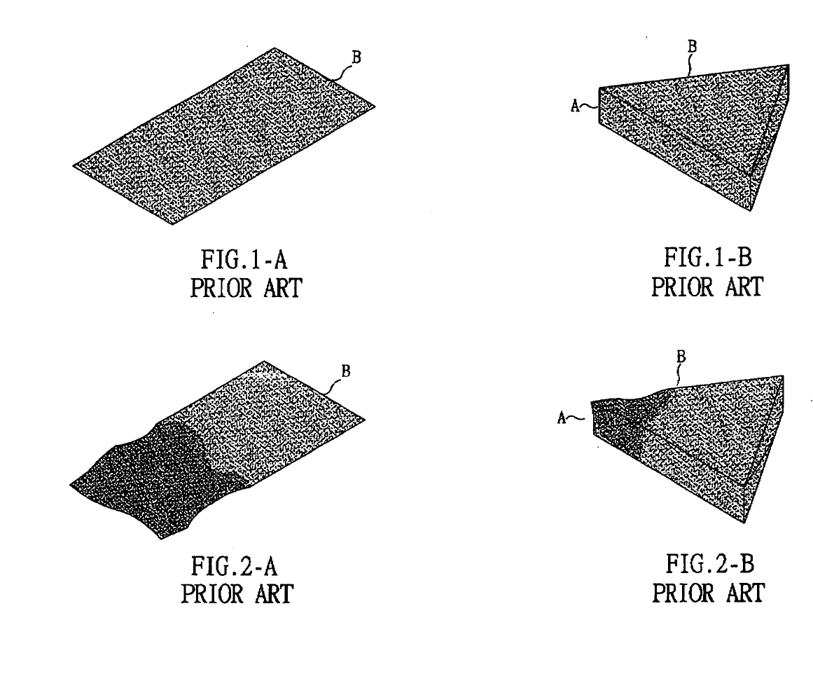

### DETAILED DESCRIPTION OF THE INVENTION

To enable an understanding of the structural features, operation, and other items of the invention for purposes of examination and reference, the brief description of the drawings are accompanied by the following detailed description of the invention.

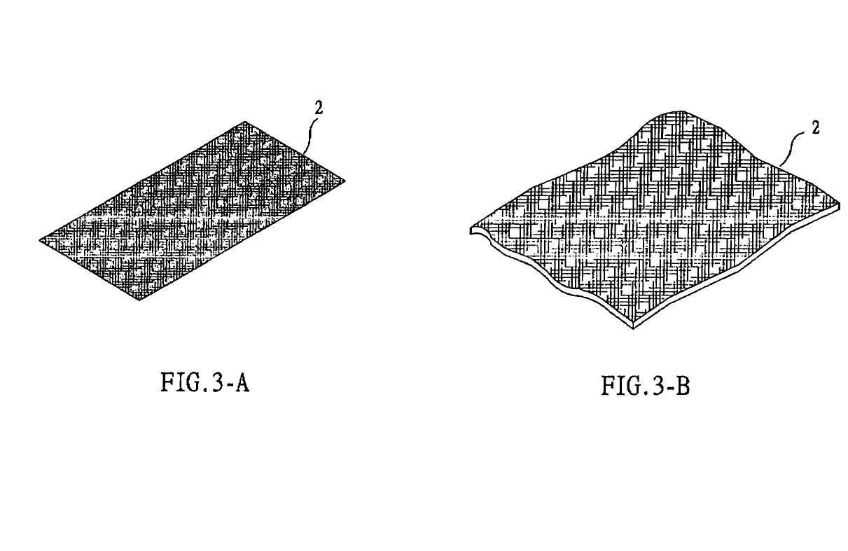

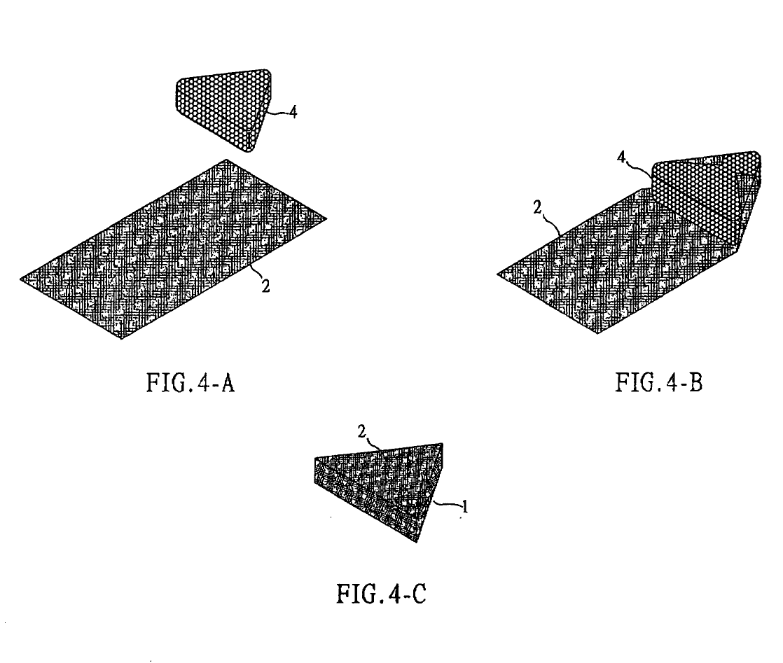

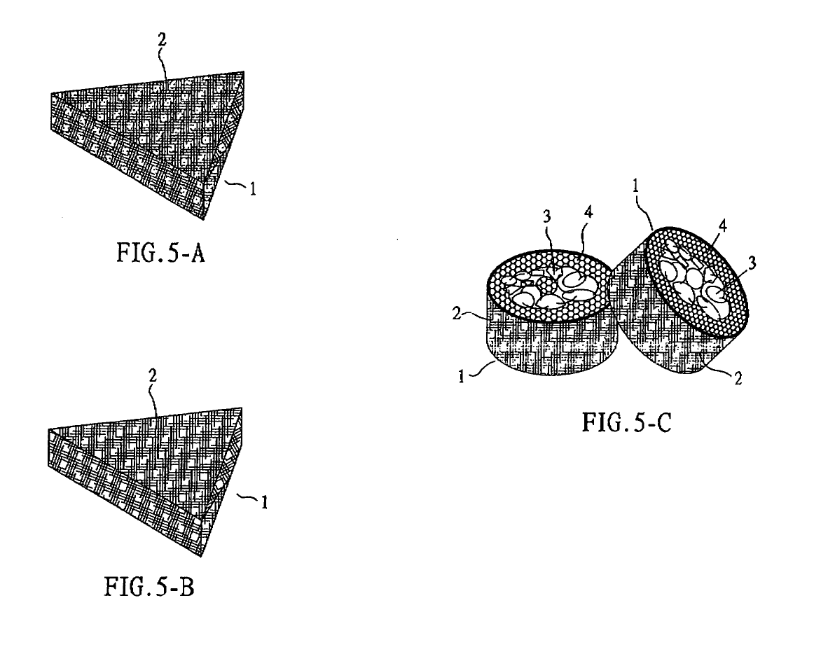

Referring to FIG. 3, FIG. 4, FIG. 5-A, FIG. 5-B, and FIG. 5-C, the rice ball structure of the invention herein is comprised of a rice ball 1, dried meat 2, and filling 3.

The said rice ball 1 consists of first placing a given quantity of cooked rice 4 into rice ball 1 forming molds of different shape, a filling 3 composed of personally preferred condiments and ingredients is next placed onto the cooked rice 4, and then another given quantity of cooked rice 4 is added into the rice ball 1 forming molds over the said condiments and ingredients, which are finally pressed into differently shaped rice balls 1, the utilization of the said rice ball 1 forming molds facilitating the convenient, rapid (shorter cooking time), and sanitary processing of the rice ball 1 into a food product.

The said dried meat 2 consists of animal and vegetable ingredients (such as chicken, pork, fish, beef, and vegetarian foods, etc.) that are processed into dried meat 2 sheets of predetermined dimensions and degrees of pliability, following which the pliable dried meat 2 is imbued with different flavors; the said dried meat 2 of predetermined dimensions and degrees of pliability are then wrapped around the said differently shaped rice balls 1, the pliability range of the dried meat 2 as the differently shaped rice balls 1 are wrapped not only facilitating the wrapping procedure, but also keeping the dried meat 2 intact and unbroken (Since conventional dried meat sheet processing typically results in a product that is thick and, furthermore, hard, with the said conventional dried meat also difficult to chew while eaten, when utilized to wrap rice balls 1, they are affected by the inherent thickness and hardness; as such, they cannot be similar to pliant dried meat 2 of the invention herein, which is not susceptible to external force when randomly bent for wrapping rice balls, because of the breakage that occurs as they are forced wrapped, a situation that does not happen with the dried meat 2 of the invention herein.) such that after differently shaped rice balls 1 are wrapped in a layer of dried meat 2, the rice ball 1 production process is complete and they are ready to be eaten.

Furthermore, after the pliable dried meat 2 is wrapped around differently shaped rice balls 1, since the dried meat 2 is not readily affected by ambient humid conditions and moisture absorption, or when unpackaged and not eaten, the dried meat 2 does not become soft and soggy as easily as sea moss B, but is capable of convenient and simple extended shelf life, warehousing, and storage that involves no additional difficulty; as the dried meat 2 is not susceptible to moisture which prevents softening and sogginess and, furthermore, for culinary enjoyment, a variety of animal and vegetable ingredients (such as chicken, pork, fish, beef, and vegetarian foods, etc.) can be selectively added during processing to thereby integrate a range of different flavors to further enhance taste while eaten; additionally, the dried meat 2 does not stick to the hands when grasped which eliminates the trouble of having to wash up afterwards; and since the dried meat 2 is unaffected by moisture and does not become soft or soggy, the original shape of the rice ball 1 is maintained and does not deform, thereby preserving its original attractive appearance.

Furthermore, when eating the differently shaped rice balls 1 wrapped in the pliant dried meat 2 of the invention herein, since the flavor of the dried meat 2 is more abundant and even richer than that of the single-flavor sea moss B, even if there was no filling 3, eating would not be monotonous because the dried meat 2 has selectively added animal and vegetable ingredients (such as chicken, pork, fish, beef, and vegetarian foods, etc.) and the dried meat 2 is capable of additionally accommodating a range of condiments (such as sesame, nuts, peanuts, and almonds, etc. that are incompatible with sea moss) to further enhance the culinary flavor such that it exceeds that of the single-flavor sea moss B wrapping the rice ball A; moreover, after the dried meat 2 wrapping the rice ball 1 is unpackaged, it is easy to eat and, furthermore, the dried meat 2 can be eaten hot or cold; since it can be heated by microwave for hot consumption during the winter without any changes in quality (Sea moss B cannot be eaten hot because it becomes soggy after microwave heating.).

In summation of the foregoing section, since the invention herein is genuinely original and of improved practical utility and, therefore, meets the application requirements stipulated in Article 97 of the New Patent Law, the present invention is submitted to the patent bureau for review and the granting of the commensurate patent rights.

1. A rice ball structure in which a given quantity of cooked rice is first placed into rice ball forming molds of different shape, a filling composed of personally preferred condiments and ingredients is next placed onto the said cooked rice, and then another given quantity of the said cooked rice is added into the said rice ball forming molds over the said condiments and ingredients, which are finally pressed into differently shaped rice balls, the utilization of the said said rice ball forming molds facilitating the convenient, rapid (shorter cooking time) and sanitary processing of the said rice ball into a food product, the features of which are: The said dried meat is pre-processed into sheets of predetermined dimensions and degrees of pliability for wrapping the said differently shaped rice balls such that after the said differently shaped rice balls are wrapped in a layer of the said dried meat, the said rice ball production process is complete and they are ready to be eaten.

2. As mentioned in claim 1 of the rice ball structure of the invention herein, the said dried meat is produced from a range of various animal and vegetable ingredients.

3. As mentioned in claim 2 of the rice ball structure of the invention herein, the said various animal and vegetable ingredients includes chicken, pork, fish, beef, and vegetarian foods.

4. As mentioned in claim 1 of the rice ball structure of the invention herein, the said filling includes sesame, nuts, peanuts, and almonds.
